(19) United States
(12) Patent Application Publication
(10) Pub. No.: US 2024/0382934 A1
(43) Pub. Date: Nov. 21, 2024

(54) METHOD FOR MANUFACTURING COFFEE ACTIVATED CARBON USING COFFEE WASTE, COFFEE ACTIVATED CARBON MANUFACTURED USING THE SAME, AND COMBI FILTER FOR VEHICLE AIR CONDITIONING SYSTEM INCLUDING COFFEE ACTIVATED CARBON

(71) Applicants: HYUNDAI MOTOR COMPANY, Seoul (KR); KIA CORPORATION, Seoul (KR)

(72) Inventor: Kwang Mo Seong, Bucheon-si (KR)

(21) Appl. No.: 18/236,108

(22) Filed: Aug. 21, 2023

(30) Foreign Application Priority Data
May 18, 2023 (KR) 10-2023-0064258

(51) Int. Cl. B01J 20/30; B01J 20/20; B01J 20/28; B01J 20/32

(52) U.S. Cl. CPC B01J 20/3042; B01J 20/20; B01J 20/28004; B01J 20/28016; B01J 20/3007; B01J 20/3078; B01J 20/3204; B01J 20/3293; B01J 2220/4825; B01J 2220/4875; B60H 2003/0691

(57) ABSTRACT

A method for manufacturing coffee activated carbon includes performing a pretreatment process of manufacturing coffee grains using a binding mixture including coffee powder particles and a binder, performing a main treatment process of carbonizing and activating the coffee grains and manufacturing coffee activated carbon, and performing a post-treatment process of impregnating an impregnating agent including an amine group into the coffee activated carbon.

### CROSS REFERENCE TO RELATED APPLICATIONS

This application claims benefit of priority to Korean Patent Application No. 10-2023-0064258 filed on May 18, 2023, in the Korean Intellectual Property Office, the disclosure of which is incorporated herein by reference in its entirety.

### BACKGROUND

### 1. Field

The present disclosure relates to a method for manufacturing coffee activated carbon using coffee waste, coffee activated carbon manufactured using the same, and a combi filter for a vehicle air conditioning system including the coffee activated carbon.

### 2. Description of Related Art

Recently, as coffee consumption has gradually increased, the amount of discharged coffee residues (hereinafter referred to as ‘coffee waste’) remaining after processing coffee beans is also increasing. Specifically, only about 1 to 2% by weight of coffee beans are used as an undiluted coffee solution, and most of the coffee beans are discharged as coffee waste, resulting in a huge amount of coffee waste. Most of such coffee waste is buried or incinerated, but there may be a problem in that groundwater may be contaminated when the coffee waste containing moisture and various organic materials is buried, and environments may be contaminated because greenhouse gases are discharged the coffee waste is incinerated. Accordingly, there is a need to develop a technology for eco-friendly processing of coffee waste.

Meanwhile, respective countries are declaring carbon neutrality to cope with environmental pollution and climate change worldwide. As one of various measures to achieve such carbon neutrality, a method for using recycled materials for more than a certain percentage of materials applied to vehicles is being discussed.

On the other hand, as activated carbon applied to a combi filter for a vehicle air conditioning system, activated carbon manufactured by carbonizing and activating precursors formed of various carbon materials, such as wood, coal, lignite, and coconut shells, is mainly used. In this regard, Korean Unexamined Patent Application No. 10-2003-0028325 discloses applying activated carbon manufactured by carbonizing and activating coconut shells to a filter. However, environmental pollution and greenhouse gas emissions are caused in the process of securing wood, coal, lignite, and coconut shells as precursors, and since activated carbon formed of wood, coal, lignite and coconut shells is not a recycled material, the prior art is technology making it difficult to meet the purpose of carbon neutrality.

Accordingly, by recycling coffee waste to manufacture activated carbon applied to the combi filter for a vehicle air conditioning system without landfill or incineration, and as the coffee waste is treated in an environmentally friendly manner and meets the purpose of carbon neutrality at the same time, a technology for manufacturing activated carbon by recycling the coffee waste is being developed.

Accordingly, in order for activated carbon manufactured using coffee waste to replace activated carbon according to a conventional art, activated carbon manufacturing technology using coffee waste having dust collection efficiency, odor control efficiency and deodorization efficiency, similar to dust collection efficiency, odor control efficiency and deodorization efficiency of activated carbon according to the conventional art is required.

### SUMMARY

An aspect of the present disclosure is to provide a method for manufacturing coffee activated carbon using coffee waste, coffee activated carbon manufactured by the same, and a combi filter for a vehicle air conditioning system having improved pressure loss, improved dust collection efficiency, an improved dust collection amount, improved odor control efficiency, and improved deodorization efficiency by including the coffee activated carbon.

According to an aspect of the present disclosure, provided is a method for manufacturing coffee activated carbon, the method including performing a pretreatment process of manufacturing coffee grains using a binding mixture including coffee powder particles and a binder, performing a main treatment process of carbonizing and activating the coffee grains and manufacturing coffee activated carbon, and performing a post-treatment process of impregnating an impregnating agent including an amine group into a surface of the coffee activated carbon.

According to another aspect of the present disclosure, is provided coffee activated carbon manufactured according to method for manufacturing coffee activated carbon, in which an impregnating agent including an amine group is impregnated.

According to another aspect of the present disclosure, provided is a combi filter for a vehicle air conditioning system, including the coffee activated carbon.

In a method for manufacturing coffee activated carbon according to example embodiments of the present disclosure, the coffee activated carbon may be manufactured by performing a pretreatment process of manufacturing coffee grains using a binding mixture including coffee powder particles and a binder, performing a main treatment process of manufacturing the coffee activated carbon by carbonizing and activating the coffee grains, and performing a post-treatment process of impregnating an impregnating agent including an amine group into a surface of the coffee activated carbon, and a combi filter for a vehicle air conditioning system including the coffee activated carbon can have improved pressure loss, improved dust collection efficiency, an improved dust collection amount, improved odor control efficiency, and improved deodorization efficiency.

The combi filter for a vehicle air conditioning system including the coffee activated carbon manufactured according to the method for manufacturing coffee activated carbon may have improved pressure loss, improved dust collection efficiency, an improved dust collection amount, and improved deodorization efficiency, and thus replace conventional activated carbon manufactured using wood, coal, lignite, and coconut shells, and accordingly, the method for manufacturing coffee activated carbon may be an eco-friendly technology that prevents environmental pollution generated during the conventional manufacturing of activated carbon and greenhouse gas discharge.

### BRIEF DESCRIPTION OF THE FIGURES

The above and other aspects, features, and advantages of the present disclosure will be more clearly understood from the following detailed description, taken in conjunction with the accompanying drawings, in which:

FIGS. 1, 2, 3, and 4 are flowcharts illustrating a method for manufacturing coffee activated carbon according to example embodiments of the present disclosure;

FIG. 5 is a flowchart illustrating a method for manufacturing a combi filter for a vehicle air conditioning system according to example embodiments of the present disclosure; and

FIGS. 6 and 7 are cross-sectional views illustrating a filter fabric used in a method for manufacturing a combi filter for a vehicle air conditioning system according to example embodiments of the present disclosure.

### DETAILED DESCRIPTION

Hereinafter, various embodiments according to the present disclosure will be described, but example embodiments may be modified into various different forms, and the scope thereof is not limited to the embodiments described below.

### Method for Manufacturing Coffee Activated Carbon

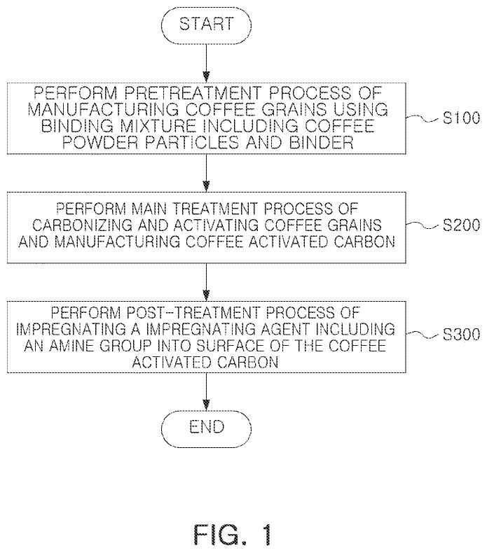

A method for manufacturing coffee activated carbon using coffee waste according to the present disclosure will be described with reference to FIGS. 1 to 3. FIGS. 1 to 4 are flowcharts illustrating a method for manufacturing coffee activated carbon according to example embodiments of the present disclosure.

Referring to FIG. 1, a method for manufacturing coffee activated carbon according to example embodiments of the present disclosure may include an operation of performing a pretreatment process (S100), an operation of performing a main treatment process (S200), and an operation of performing a post-treatment process (S300).

First, the pretreatment process of manufacturing coffee grains using a binding mixture including coffee powder particles and a binder may be performed. Then, the main treatment process of manufacturing coffee activated carbon by carbonizing and activating the coffee grains may be performed. Then, the post-treatment process of impregnating an impregnating agent including an amine group into a surface of the coffee activated carbon may be performed.

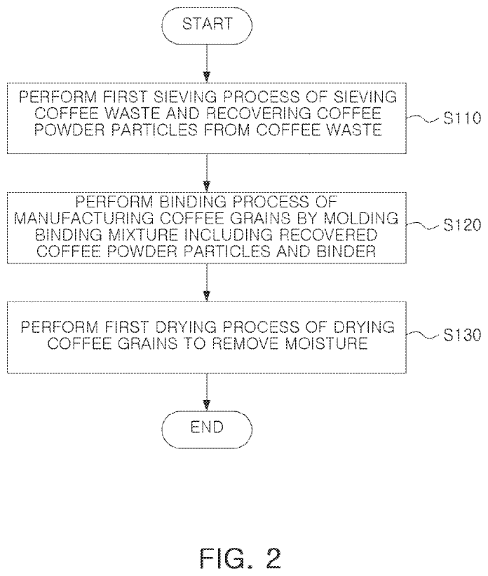

Referring to FIGS. 1 and 2, the operation of performing the pretreatment process (S100) may include an operation of performing a first sieving process (S110), an operation of performing a binding process (S120), and an operation of performing a first drying process (S130).

First, the first sieving process of sieving the coffee waste to remove foreign substances such as vinyl and the like from the coffee waste and recover the coffee powder particles may be performed.

In the operation of performing the first sieving process (S110), the coffee powder particles having an average particle diameter D₅₀ of about 400 μm may be obtained by sieving the coffee waste with a sieve having a sieve opening of about 1900 μm to about 4040 μm. As the foreign substances included in the coffee waste are removed through the first sieving process, the coffee powder particles having an average particle diameter D₅₀ within this range may be recovered, and then, in a binding process described below, the coffee grains having an average particle diameter D₅₀ of about 3000 μm are smoothly formed, and in the main treatment process described below, high-quality coffee activated carbon may be manufactured by preventing contamination due to foreign substances and a decrease in heat transfer efficiency.

In example embodiments, the coffee waste may include about 60 wt % or more of moisture based on the total weight of the coffee waste.

In an example embodiment, the first sieving process may be performed by adding the coffee waste into a vibration screen device and performing vibration screening treatment for about 10 to 60 minutes.

Then, the binding process of manufacturing the coffee grains may be performed by molding the binding mixture including the recovered coffee powder and the binder.

The binding process may be performed by adding and mixing the binder with the recovered coffee powder particles. In example embodiments, when the binder is added to the recovered coffee powder and then mixed, water may also be added and mixed.

In an example embodiment, the coffee grains manufactured in the binding process may have an average particle diameter D50 of about 3000 μm.

In example embodiments, the binder may be used in an amount of about 1 wt % to about 5 wt % based on the total weight of the binding mixture. When the binder is used in an amount of less than about 1 wt % based on the total weight of the binding mixture, coffee powder particles that cannot be used to form the coffee grains may remain, the remaining coffee powder particles may be agglomerated with each other in the main treatment process to described below to form lumps, and an additional grinding process may be required to remove these lumps. When the binder is used in an amount of more than about 5 wt % based on the total weight of the binding mixture, the coffee powder particles may be excessively bound to form coffee grains having an average particle diameter D₅₀ of more than about 3000 μm. Accordingly, during a carbonization process of the main treatment process described below, since volatilization of moisture and volatile carbon does not proceed smoothly in the coffee grains, micropores may not be formed smoothly in the coffee activated carbon, which may reduce deodorization efficiency and deodorization efficiency of the coffee activated carbon.

In an example embodiment, the binding mixture may include about 95 wt % to about 99 wt % of the coffee powder particles, about 1 wt % to about 5 wt % of the binder, and the remaining water based on the total weight of the binding mixture. When the binding mixture includes water within the above-described range, the coffee powder particles may be more smoothly bound by the binder, thereby more smoothly manufacturing the coffee grains.

The binder may include, for example, at least one selected from the group consisting of viscous tree extracts such as beeswax, agar, starch, and a resin.

On the other hand, a proportion of coffee activated carbon having an average particle diameter D₅₀ of about 320 μm may be large among the coffee activated carbon sieved in a second sieving process described below by the binding process, which will be described in detail in an operation of performing the second sieving process.

Then, a first drying process of removing moisture by drying the coffee grains may be performed.

In example embodiments, the coffee grains dried through the first drying process may include about 13 wt % or less of moisture based on the total weight of the coffee grains.

In an example embodiment, the first drying process may be performed by adding the coffee powder particles into an oven device and drying the coffee powder particles at a temperature of about 100° C. to about 120° C. for about 2 to about 5 hours.

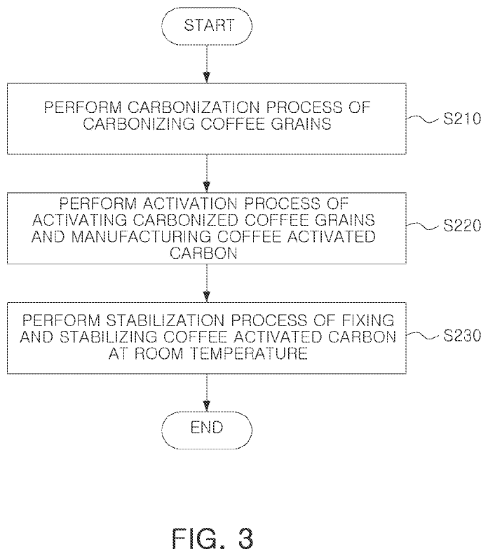

Referring to FIGS. 1 and 3, the operation of performing the main treatment process (S200) may include an operation of performing a carbonization process (S210) and an operation of performing an activation process (S220).

First, the carbonization process of carbonizing the coffee grains may be performed.

In the operation of performing the carbonization process (S210), the coffee grains may be added into a thermal decomposition furnace and carbonized at a temperature of about 300° C. to 750° C.

Because moisture and volatile carbon are volatilized in the coffee grains through the carbonization process, the coffee grains may include only fixed carbon. Meanwhile, the moisture and the volatile carbon may be gasified and discharged to the outside by thermal decomposition.

When the coffee powder particles are carbonized at a temperature of less than about 300° C., volatilization of moisture and volatile carbon may be insufficient to cause organic materials to remain. When the coffee powder particles are carbonized at a temperature of more than about 750° C., a large amount of energy or fuel may be required, which may increase manufacturing costs of coffee activated carbon.

In an example embodiment, the carbonization process may be performed for about 1 to about 4 hours.

In an example embodiment, the thermal decomposition furnace may be in an inert state. Specifically, the thermal decomposition furnace may be in an inert state by adding an inert gas into the thermal decomposition furnace or recirculating a portion of an exhaust gas discharged through an outlet to the thermal decomposition furnace. The exhaust gas may include, for example, carbon dioxide (CO₂).

In an example embodiment, the inert gas may include, for example, at least one selected from the group consisting of nitrogen (N₂), carbon dioxide (CO₂), and argon (Ar).

Then, the activation process of manufacturing the coffee activated carbon by activating carbonized coffee grains may be performed.

In the operation of performing the activation process (S120), the carbonized coffee grains and active gas may be added into the thermal decomposition furnace to activate the carbonized coffee grains at a temperature of about 900° C. to about 1100° C. to manufacture the coffee activated carbon.

In an example embodiment, the activation process may be performed for about 2 to about 6 minutes.

Through the activation process, the coffee activated carbon may have a pore structure. Specifically, pores having various sizes such as macro pores, mesopores, and micropores may be formed in the coffee activated carbon through the activation process.

Accordingly, the coffee activated carbon may have a high BET specific surface area.

In an example embodiment, the coffee activated carbon may have a BET specific surface area of about 1000 m²/g or more. A combi filter for a vehicle air conditioning system including the coffee activated carbon having a BET specific surface area in the above-described range may have improved pressure loss, improved dust collection efficiency, an improved dust collection amount, and improved deodorization efficiency.

When the coffee powder particles are activated at a temperature of less than about 900° C., because the micropores are not sufficiently formed in the coffee activated carbon, the coffee activated carbon may not have a BET specific surface area of about 1000 m²/g or more. When the coffee powder particles are activated at a temperature of more than about 1,100° C., a large amount of energy or fuel may be required, which may increase manufacturing costs of coffee activated carbon.

In an example embodiment, the active gas may include, for example, at least one selected from the group consisting of steam (H₂O), carbon dioxide (CO₂), potassium hydroxide (KOH), sodium hydroxide (NaOH), potassium carbonate (K₂CO₃), zinc chloride (ZnCl₂), and phosphoric acid (H₃PO₄).

Meanwhile, agglomeration between the coffee grains may occur in the process of forming the coffee grains into the coffee activated carbon through the carbonization process and the activation process, which many increase the average particle diameter D₅₀ of the coffee activated carbon. Specifically, the coffee activated carbon may have an average particle diameter D₅₀ of about 850 μm to about 900 μm.

In example embodiments, the operation of performing the main treatment process (S200) may further include an operation of performing a stabilization process of fixing and stabilizing the coffee activated carbon at room temperature (S230) after performing the activation process (S220). In this case, the room temperature is, for example, about 5° C. to about 40° C., or about 10° C. to about 30° C., or about 15° C. to about 25° C., preferably about 25° C.

The pore structure of the coffee activated carbon may be stabilized through the stabilization process.

In an example embodiment, the stabilization process may be performed for about 2 to about 6 hours.

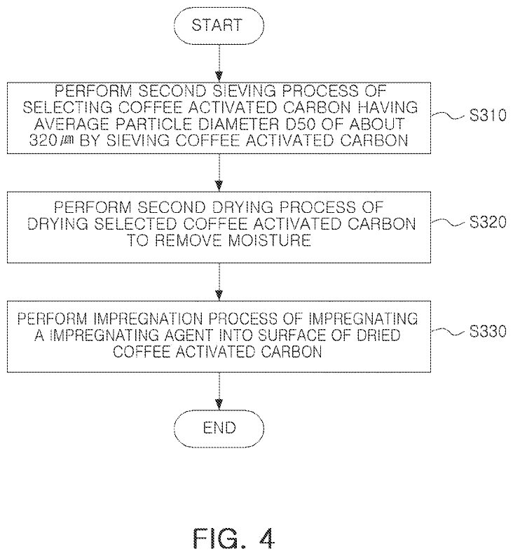

Referring to FIGS. 1 and 4, the operation of performing the post-treatment process (S300) may include an operation of performing a second sieving process (S310), an operation of performing a second drying process (S320), and an operation of performing an impregnation process (S330).

First, the second sieving process of selecting the coffee activated carbon having an average particle diameter D₅₀ of about 320 μm by sieving the coffee activated carbon may be performed.

In the operation of performing the second sieving process (S210), the coffee activated carbon may be sieved with a sieve having a sieve opening of about 185 μm to about 864 μm.

The combi filter for a vehicle air conditioning system including the coffee activated carbon having the above-described average particle diameter D₅₀, may have improved pressure loss, improved dust collection efficiency, an improved dust collection amount, and improved deodorization efficiency. Furthermore, because the coffee activated carbon having the average particle diameter D₅₀ is not scattered during the manufacturing of the combi filter, contamination of manufacturing equipment by the coffee activated carbon may be prevented and the manufacturing environment may be improved.

In an example embodiment, the second sieving process may be performed by adding the coffee activated carbon into a vibration screen device and performing vibration screening treatment for about 1 to about 3 hours.

On the other hand, the proportion of the coffee activated carbon having an average particle diameter D₅₀ of about 320 μm may be large among the coffee activated carbon sieved in the second sieving process by the binding process. Specifically, the proportion of the coffee activated carbon having the average particle diameter D₅₀ of about 320 μm among the sieved coffee activated carbon may be about 80% to about 95%. Since the coffee powder particles do not remain by binding the coffee powder particles through the binding process to form coffee grains having an average particle diameter D₅₀ of about 3000 μm, the coffee powder particles may be suppressed from forming lumps or fine powder particles during the subsequent main treatment process. Accordingly, the binding process may improve a ratio of the coffee activated carbon having an average particle diameter D₅₀ of about 320 μm among the sieved coffee activated carbon.

In example embodiments, the operation of performing the post-treatment process (S300) may further include an operation of performing a grinding process of grinding the coffee activated carbon before an operation of performing the second sieving process (S310).

By performing the grinding process, the coffee activated carbon having the average particle diameter D₅₀ of about 320 μm may be selected more smoothly in the second sieving process.

In an example embodiment, the grinding process may be performed by adding the coffee activated carbon into a grinding device such as a blade mill and grinding the coffee activated carbon to about 1000 g/hr.

Then, the second drying process of removing moisture by drying the coffee activated carbon selected by the second sieving process may be performed.

In the operation of performing the second drying process (S320), moisture adsorbed into pores of the coffee activated carbon may be removed to include about 5 wt % or less of moisture based on the total weight of the coffee activated carbon. Since the coffee activated carbon includes moisture in the above-described range, the moisture may be attached to an adsorption point to a surface of the coffee activated carbon instead of gas, thereby minimizing a decrease in deodorization efficiency.

In an example embodiment, the first drying process may be performed by adding the coffee waste into an oven device and drying the coffee waste at a temperature of about 100° C. to about 120° C. for about 1 to about 2 hours.

Then, the impregnation process of impregnating the impregnation agent to dried coffee activated carbon may be performed.

The impregnation process may be performed by adding the impregnation agent to the coffee activated carbon and then physically mixing the impregnation agent.

The impregnating agent may have deodorizing characteristics that remove odor components having low molecular weight such as acetic acid, formaldehyde, and acetaldehyde of the coffee activated carbon. Accordingly, the combi filter for a vehicle air conditioning system including the coffee activated carbon to which the impregnating agent is attached may have improved deodorization efficiency.

In an example embodiment, the impregnating agent may include, for example, at least one selected from the group consisting of piperazine, arginine, alanine, glutamine, glycine, threonine, and histidine.

In example embodiments, the impregnating agent may be used in an amount of about 2 wt % to about 10 wt % based on the total weight of the coffee activated carbon. When the impregnating agent is used in an amount of less than about 2 wt % based on the total weight of the coffee activated carbon, because the amount of the impregnating agent attached to the surface of the coffee activated carbon is small, the deodorization efficiency of the coffee activated carbon for the odor components such as acetic acid and acetaldehyde may be reduced. When the impregnating agent is used in an amount of more than about 10 wt % based on the total weight of the coffee activated carbon, a specific surface area of the coffee activated carbon may be reduced by an excessive amount of the impregnating agent impregnated to the surface of the coffee activated carbon, thereby reducing the deodorization efficiency and deodorization efficiency of the coffee activated carbon.

In example embodiments, after performing the impregnation process, a sealing process of sealing the coffee activated carbon may be performed. Pollutants in the atmosphere may be adsorbed to the coffee activated carbon by the impregnating agent impregnated to the coffee activated carbon, but the pollutants in the atmosphere may be prevented from being impregnated to the coffee activated carbon by performing the sealing process.

Accordingly, the manufacturing of the coffee activated carbon may be completed.

As described above, the coffee activated carbon may be manufactured by performing the pretreatment process of manufacturing the coffee grains using the binding mixture including the coffee powder particles and the binder, performing the main treatment process of manufacturing the coffee activated carbon by carbonizing and activating the coffee grains, and performing the post-treatment process of impregnating the impregnating agent containing the amine group to a surface of the coffee activated carbon, and the combi filter for a vehicle air conditioning system including the coffee activated carbon may have improved pressure loss, improved dust collection efficiency, an improved dust collection amount, improved odor control efficiency, and improved deodorization efficiency.

On the other hand, in the case of conventionally manufacturing activated carbon using wood, coal, lignite, and coconut shells, environmental pollution and greenhouse gas emissions may occur in the process of securing wood, coal, lignite, and coconut shells, and manufacturing the activated carbon. However, the combi filter for a vehicle air conditioning system including the coffee activated carbon manufactured according to the method for manufacturing coffee activated carbon of the present disclosure may have improved pressure loss, improved dust collection efficiency, an improved dust collection amount, and improved deodorization efficiency, and thus replace conventional activated carbon manufactured using wood, coal, lignite, and coconut shells, and accordingly, the method for manufacturing coffee activated carbon may be an eco-friendly technology that prevents environmental pollution generated during the conventional manufacture of activated carbon and greenhouse gas discharge.

### Method for Manufacturing Combi Filter for Vehicle Air Conditioning System

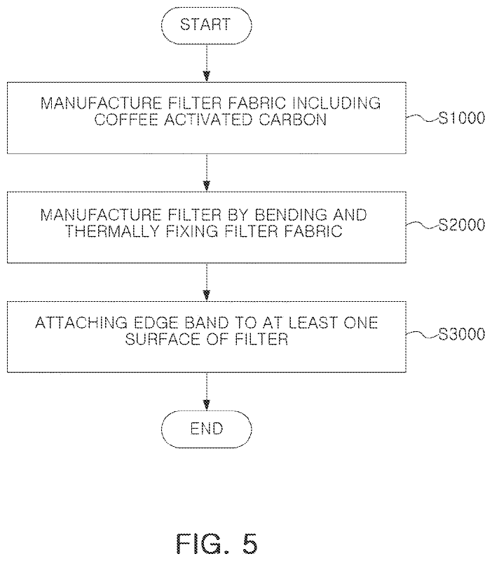

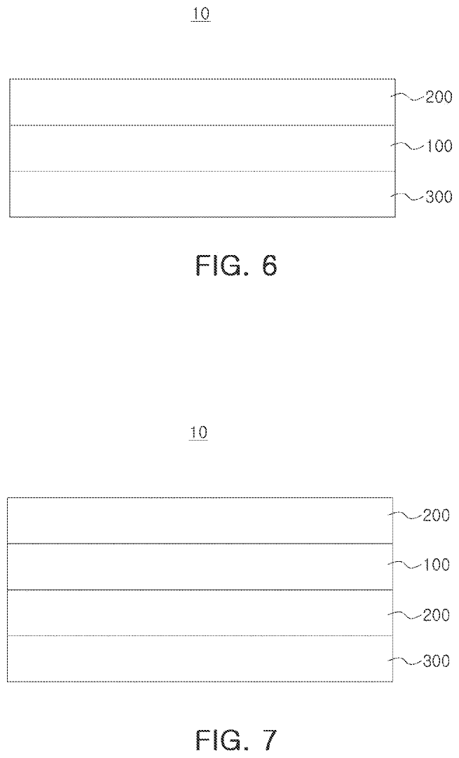

Hereinafter, a method for manufacturing a combi filter for a vehicle air conditioning system according to the present disclosure will be described referring to FIGS. 5 to 7. FIG. 5 is a flowchart illustrating a method for manufacturing a combi filter for a vehicle air conditioning system according to example embodiments of the present disclosure, and FIGS. 6 and 7 are cross-sectional views illustrating a filter fabric used in a method for manufacturing a combi filter for a vehicle air conditioning system according to example embodiments of the present disclosure.

According to FIGS. 5 to 7, the method for manufacturing a combi filter for a vehicle air conditioning system according to example embodiments of the present disclosure may include an operation of manufacturing a filter fabric 10 including the coffee activated carbon (S1000), an operation of manufacturing a filter by bending and thermally fixing the filter fabric 10 (S2000), and an operation of attaching an edge band to at least one surface of the filter (S3000).

First, the filter fabric 10 including the coffee activated carbon may be manufactured.

The operation of producing the filter fabric 10 (S1000) may include an operation of forming an adsorption layer 100 including the coffee activated carbon, an operation of forming a support layer 200 including a nonwoven fabric on at least one surface of the adsorption layer 100, and an operation of forming a dust collecting layer 300 on the adsorption layer 100 or the support layer 200.

As the adsorption layer 100 includes the coffee activated carbon, the combi filter may perform an adsorption function such as dust collection and deodorization.

The support layer 200 perform a function of fixing the adsorption layer 100 and maintaining a shape of the filter fabric 10, and the support layer 200 may be used without limitation as long as it is commonly used to perform such a function. In an example embodiment, the nonwoven fabric included in the support layer 200 may include, for example, at least one selected from the group consisting of polyethylene terephthalate (PET), polypropylene (PP), and polyurethane (PU).

The dust collecting layer 300 performs a function of collecting dust in the combi filter, and the dust collecting layer 300 may be used without limitation as long as it is commonly used to perform such a function. In an example embodiment, the dust collecting layer 300 may include, for example, at least one selected from the group consisting of polyethylene terephthalate (PET), polypropylene (PP), and polyurethane (PU).

Meanwhile, the filter fabric 10 may be manufactured to have various multilayer structures.

Specifically, in an example embodiment, the filter fabric 10 may be manufactured by forming the adsorption layer 100, forming the support layer 200 on one side of the adsorption layer 100, and then forming the dust collection layer 300 on the other side of the adsorption layer 100 (see FIG. 6).

In an example embodiment, the filter fabric 10 may be manufactured by forming the adsorption layer 100, forming the support layers 200 on both sides of the adsorption layer 100, and then forming the dust collection layer 300 on one of the support layers 200 (see FIG. 7).

Then, the filter may be manufactured by bending and thermally fixing the filter fabric 10.

The operation of manufacturing the filter (S2000) may include an operation of bending the filter fabric 10 at intervals of about 10 mm to about 30 mm, and an operation of manufacturing the filter by thermally fixing the bent filter fabric at a temperature of about 80° C. or higher. As the filter fabric is bent, it may have a bend valley.

In an example embodiment, the bent filter fabric may be thermally fixed at a rate of about 52 valley/min.

In an example embodiment, the operation of manufacturing the filter (S2000) may further include an operation of cutting the filter according to a size of an applied combi filter after the operation of manufacturing the filter.

Then, an edge band may be attached to at least one surface of the filter.

In example embodiments, the edge band may be attached to at least two surfaces of the filter.

The edge band may perform a function of fixing the filter, and the edge band may be used without limitation as long as it is generally used to perform the function. In an example embodiment, the edge band may include, for example, polyethylene terephthalate.

Accordingly, the manufacture of the combi filter for a vehicle air conditioning system may be completed.

### EXAMPLE

Hereinafter, the present disclosure will be described in more detail with reference to specific example embodiments. However, the following inventive example illustrates an example embodiment of the present invention, and the present disclosure is not limited thereto.

### Inventive Example 1

Coffee waste was put into an oven device (S-SHOV150) of SCENG Co., Ltd., and was subjected to vibration screening for 60 minutes. Specifically, the coffee waste was sieved with a sieve having a sieve opening of 1900 μm to recover coffee powder particles.

Then, an average particle diameter D₅₀ of the coffee powder particles was measured using ZEN3600 of Malvern Instruments. In this case, the average particle diameter D₅₀ of the coffee powder particles was measured to be 400 μm.

Then, a binder mixture was manufactured by adding a binder to the coffee powder particles, and then the binder was molded to prepare coffee grains. In this case, the binding mixture included 97 wt % of the coffee powder particles and 3 wt % of the binder based on the total weight of the binding mixture, and starch was used as the binder.

Then, the coffee grains were put into the oven device (S-SHOV150) of SCENG Co., Ltd., and were dried at a temperature of 120° C. for 5 hours. The dried coffee grains included 13 wt % of moisture based on the total weight of the coffee powder particles.

Then, the coffee grains were put into a thermal decomposition furnace of Korea Thermo Tech Co., Ltd., and were carbonized at a temperature of 750° C. for 1 hour. On the other hand, when carbonizing the coffee grains, carbon dioxide (CO₂) was added into the thermal decomposition furnace so that the thermal decomposition furnace was maintained in an inactive state.

Then, steam (H₂O) was added into the thermal decomposition furnace to activate the carbonized coffee grains at a temperature of 1100° C. for 3 minutes. As a result, coffee activated carbon having a pore structure was manufactured.

Then, a BET specific surface area of the coffee activated carbon was measured using ASAP2420 of Micromeritics. Specifically, helium was used as a carrier gas, nitrogen was used as an adsorption gas, and a BET specific surface area was measured by 5 predefined points method of BET relative pressure (P/P₀ where P is actual measurement pressure, and P₀ is saturation pressure) by continuous flow. In this case, the BET specific surface area of the coffee activated carbon was measured to be 1252 m²/g.

Furthermore, an average particle diameter D₅₀ of the coffee activated carbon was measured using ZEN3600 of Malvern Instruments. In this case, the average particle diameter D₅₀ of the coffee activated carbon was measured to be about 850 μm.

Then, the coffee activated carbon was fixed at room temperature (25° C.) and stabilized for 4 hours.

After grinding the coffee activated carbon, the ground coffee activated carbon was added into a vibration screen device (XZS400) of Hwashin Machinery Co., Ltd. and was subjected to vibration screening for 2 hours. Specifically, the coffee waste was sieved with a sieve having sieve opening of 185 μm and 864 μm, in order to select the coffee activated carbon.

Then, an average particle diameter D₅₀ of the selected coffee activated carbon was measured using ZEN3600 of Malvern Instruments. In this case, the average particle diameter D₅₀ of the selected coffee activated carbon was measured to be about 320 μm.

Then, the coffee activated carbon was added into the oven device (S-SHOV150) of SCENG Co., Ltd., and was dried at a temperature of 100° C. for 2 hours. The dried coffee activated carbon included 5 wt % of moisture based on the total weight of the coffee activated carbon.

Then, an impregnating agent was added to the coffee activated carbon and then physically mixed so as to impregnate the impregnating agent to a surface of the coffee activated carbon. More specifically, the impregnating agent was used in an amount of 2 wt % based on the total weight of the coffee activated carbon. In this case, piperazine was used as the impregnation agent.

Accordingly, the coffee activated carbon of Inventive Example 1 was manufactured.

### Comparative Example 1

Activated carbon of Comparative Example 1 is coconut activated carbon manufactured using coconut shells, and has the same BET specific surface area and average particle diameter D50 as those of the coffee activated carbon of Inventive Example 1.

### Comparative Example 2

In the same manner as in the method for manufacturing coffee activated carbon in Inventive Example 1, coffee powder particles were collected by sieving the coffee waste, the coffee powder particles were bound to manufacture coffee grains, the coffee grains were dried, carbonized, activated and stabilized to manufacture coffee activated carbon, and the coffee activated carbon was sieved and dried. However, afterwards, the impregnation agent was not attached to a surface of the coffee activated carbon.

Accordingly, the coffee activated carbon of Comparative Example 2 was manufactured.

### Manufacture of Combi Filter for Vehicle Air Conditioning System

An adsorption layer including the activated carbon of Inventive Example 1 and Comparative Examples 1 and 2, respectively, was formed, the support layer was formed on one surface of the adsorption layer, and the dust collection layer was formed on the other surface of the adsorption layer to manufacture the filter fabric. In this case, the support layer includes a polyester nonwoven fabric, and the dust collecting layer includes polypropylene.

Then, the filter fabric was bent at intervals of 30 mm using a knife-type bending device, and the bent filter fabric was thermally fixed at a temperature of 80° C. at a rate of 52 valley/min using a fixing device of a thermally fixed manner, thus manufacturing a filter.

Then, the filter was cut to a size of 227 mm wide*210 mm long*30 mm high, and then the edge band formed of a PET material was attached by applying a hot melt to two sides to four sides of the filter.

Accordingly, the combi filter for a vehicle air conditioning system of Inventive Example 1-1 and Comparative Examples 1-1 and 2-1 including the activated carbon of Inventive Example 1 and Comparative Examples 1 and 2, respectively, was manufactured.

### Pressure Loss Assessment

For the combi filters for a vehicle air conditioning system in Inventive Example 1-1 and Comparative Examples 1-1 and 2-1, a pressure loss was evaluated depending on test regulations DIN 71460-1, respectively.

Specifically, after stabilizing a test air volume of an evaluation device to 300 CMH, inlet pressure P₁ and outlet pressure P₂ were measured in a state in which the combi filter is not installed on the evaluation device, and the combi filter was mounted on the evaluation device, and also, after stabilizing the test air volume of the evaluation device to 300 CMH, inlet input pressure P₃ and outlet pressure P₄ of the combi filter were measured, respectively, and a pressure loss P was evaluated according to Equation 1 below. A pressure loss was evaluated for three or more combi filters, and an average value of pressure loss values thereof was used as a final pressure loss value.

$$P [ Pa ] = ( {P}_{3} - {P}_{4} ) - ( {P}_{1} - {P}_{2} ) \qquad Equation 1$$

### Dust Collection Efficiency Evaluation

Dust collection efficiency was evaluated in accordance with the test regulations DIN 71460-1 for the combi filters for a vehicle air conditioning system in Inventive Example 1-1 and Comparative Examples 1-1 and 2-1, respectively.

Specifically, the combi filter was mounted on the evaluation device, and the test air volume of the evaluation device was stabilized to 300 CMH, and then, ISO A2 fine dust was supplied at 10±2 mg/m³. After stabilizing a dust concentration for 10 seconds by operating a dust gauge, an inlet concentration C₁ and an outlet concentration C₂ of the combi filter were measured, respectively, and dust collection efficiency ε was evaluated according to Equation 2 below. The dust collection efficiency was evaluated for three or more combi filters, and an average value of dust collection efficiency values thereof was used as a final dust collection efficiency value.

$$ε [ \% ] = ( 1 - {C}_{2} / {C}_{1} ) \times 100 \qquad Equation 2$$

### Evaluation of Dust Collection Amount

The amount of dust collection was evaluated according to the test regulations DIN 71460-1 for the combi filters for vehicle air conditioning systems in Inventive Example 1-1 and Comparative Examples 1-1 and 2-1, respectively.

Specifically, an initial weight (W₁) of the combi filter was measured, the test air volume was stabilized to 300 CMH after the combi filter was mounted on the evaluation device, and initial pressure loss was measured. ISO A2 fine dust was supplied at 75±5 mg/m³ until the pressure loss was measured to be +50 Pa as compared to the initial pressure loss, and the dust supply was stopped when the pressure loss was measured to be +50 Pa as compared to the initial pressure loss. After removing the combi filter, a final weight W₂ of the combi filter was measured, and after measuring an area A of the filter of the combi filter, a dust collection amount L was evaluated according to Equation 3 below. Dust collection amounts were evaluated for three or more combi filters, and an average value of dust collection values thereof was used as a final dust collection value.

$$L [ mg / {m}^{2} ] = ( {W}_{2} - {W}_{1} ) / A \qquad Equation 3$$

### Evaluation of Deodorization Efficiency

Combi filters for a vehicle air conditioning system in Inventive Example 1-1 and Comparative Examples 1-1 and 2-1 were evaluated in accordance with the test regulations DIN 71460-2, respectively.

Specifically, the combi filter was stabilized in a standard state for 24 hours or more. Then, an interior of the evaluation device was purged and cleaned using N₂ gas for 15 minutes at least once before supplying gas to be evaluated, a test air volume of the evaluation device was set to 150 CMH, and supply concentration conditions for each gas to be evaluated (Toluene 80±8 ppm, n-Butane 80±8 ppm, SO₂ 35+3 ppm) were set. Then, the evaluation was advanced by mounting the combi filter on the evaluation device, and applying the test air volume and the supply concentration for each gas to be evaluated. A time at which the concentration of each gas to be evaluated at an inlet of the combi filter reaches an evaluation reference concentration was set as an evaluation start time, the concentration C₁ and the outlet concentration C₂ of the combi filter were measured one minute later, and deodorization efficiency E₁ was evaluated according to Equation 4 below. The deodorization efficiency was evaluated for three or more combi filters, and an average value of deodorization efficiency values thereof was used as a final deodorization efficiency value.

$${E}_{1} [ \% ] = ( 1 - {C}_{2} / {C}_{1} ) \times 100 \qquad Equation 4$$

### Deodorization Efficiency Evaluation

Heating, ventilation and air conditioning (HVAC) module unit evaluation was performed on the combi filters for a vehicle air conditioning system of Inventive Example 1-1 and Comparative Examples 1-1 and 2-1, respectively.

Specifically, the combi filter was mounted on a blower and installed inside a 1 m³ chamber, and then, acetic acid and acetaldehyde were supplied at a certain concentration (acetic acid 15±2 ppm and acetaldehyde 15±2 ppm) for each gas to be evaluated, and the blower was operated at 600 CMH for 5 minutes. An initial concentration C₃ before operation the blower and a late concentration C₄ after operating the blower for 5 minutes were measured, and deodorization efficiency E₂ was evaluated according to Equation 5 below. Deodorization efficiency was evaluated for three or more combi filters, and an average value of deodorization efficiency values thereof was used as a final deodorization efficiency value.

$${E}_{2} [ \% ] = ( 1 - {C}_{4} / {C}_{3} ) \times 100 \qquad Equation 5$$

Evaluation results for pressure loss, dust collection efficiency, a dust collection amount, odor control efficiency, and deodorization efficiency of the combi filters for a vehicle air conditioning system according to Inventive Example 1-1 and Examples 1-1 and 2-1 are shown in Table 1 below.

TABLE 1

| | | Inventive | | |
|---|---|---|---|---|
| | | Example | Comparative | Comparative |
| | | 1-1 | Example 1-1 | Example 2-1 |
| Pressure Loss (Pa) | | 78 | 81 | 80 |
| Dust Collection Efficiency (%) | | 96.8 | 97.6 | 97.6 |
| Dust Collection Amount (g/m²) | | 14.5 | 17 | 15.3 |
| Odor Control | n-butane | 68 | 72 | 80 |
| Efficiency (%) | Toluene | 88 | 88 | 91 |
| | Sulfur dioxide | 82 | 79 | 76 |
| Deodorization | Acetic acid | 99 | 90 | 99 |
| Efficiency (%) | Acetaldehyde | 98 | 90 | 78 |

As can be seen from Table 1, it was confirmed that the combi filter for a vehicle air conditioning system of Inventive Example 1-1 had pressure loss, dust collection efficiency, dust collection amount, odor control efficiency, and deodorization efficiency superior or similar to those of the combi filter for a vehicle air conditioning system of Comparative Example 1-1. Specifically, it was confirmed that the combi filter for a vehicle air conditioning system of Inventive Example 1-1 has better sulfur dioxide deodorization efficiency and acetic acid and acetaldehyde deodorization efficiency than those of the combi filter for a vehicle air conditioning system of Comparative Example 1-1, had the same toluene deodorization efficiency as that of the combi filter for a vehicle air conditioning system of Comparative Example 1-1, and had pressure loss, dust collection efficiency, dust collection amount, and n-butane dissipation efficiency similar to those of the combi filter for a vehicle air conditioning system of Comparative Example 1-1. Based on these results, it is determined that the combi filter for a vehicle air conditioning system of Inventive Example 1-1 has excellent pressure loss, excellent dust collection efficiency, an excellent dust collection amount, and excellent deodorization efficiency, by including the coffee activated carbon of Inventive Example 1. From this, it may be seen that the combi filter for a vehicle air conditioning system including the coffee activated carbon manufactured according to the method for manufacturing the coffee activated carbon according to the present disclosure has excellent pressure loss, excellent dust collection efficiency, an excellent dust collection amount, and excellent deodorization efficiency. Accordingly, it may be seen that the coffee activated carbon manufactured according to the method for manufacturing the coffee activated carbon of the present invention may replace the activated carbon manufactured using the coconut shells.

Furthermore, it was confirmed that the combi filter for a vehicle air conditioning system of Inventive Example 1-1 has better sulfur dioxide deodorization efficiency and acetaldehyde deodorization efficiency than the combi filter for a vehicle air conditioning system of Comparative Example 2-1. From this, it may be seen that since the method for manufacturing the coffee activated carbon of the present disclosure includes the operation of performing the impregnation process, the odor control performance and deodorization performance of the combi filter for a vehicle air conditioning system of the present disclosure are further improved.

Although example embodiments of the present disclosure have been described in detail above, this is merely exemplary, and those skilled in the art will understand that various modifications and equivalent other embodiments are possible therefrom. Accordingly, the true technical protection scope of the present disclosure shall be determined by the technical concept of the appended claims.

The specific executions described in the example embodiments are example embodiments and do not in any way limit the scope of the example embodiments. In addition, if a component has no specific mention such as “essential” or “important,” it may not be an essential component for an application of the present disclosure.

The use of the term “the” and similar indicative terms in the specification of the example embodiment (especially in the scope of the claims) may correspond to both singular and plural forms. In addition, when the range is described in the example embodiment, it includes an invention applying individual values belonging to the range (unless otherwise described), and each individual value constituting the range is described in the detailed description. Finally, if there is no clear order or contrary description for the operations constituting the method according to the example embodiment, the operations may be performed in an appropriate order. The example embodiments are not necessarily limited according to the order of description of the operations. In the example embodiments, the use of all examples or exemplary terms (e.g., and the like, or the like) is simply meant to describe the example embodiments in detail, and unless limited by the claims, the scope of the example embodiment is not limited by the examples or exemplary terms. In addition, it may be seen by those skilled in the art that the example embodiments may be configured according to design conditions and factors within the scope of the claims or their equivalents to which various modifications, combinations, and changes are added.

1. A method for manufacturing coffee activated carbon, the method comprising:
performing, by a sieve and an oven device, a pretreatment process of manufacturing coffee grains using a binding mixture including coffee powder particles and a binder;
performing, by a thermal decomposition furnace, a main treatment process of carbonizing and activating the coffee grains and manufacturing coffee activated carbon; and
performing a post-treatment process of impregnating an impregnating agent including an amine group into a surface of the coffee activated carbon.

2. The method for manufacturing coffee activated carbon according to claim 1, wherein the binder includes at least one selected from the group consisting of beeswax, agar, starch, and a resin.

3. The method for manufacturing coffee activated carbon according to claim 1, wherein in the pretreatment process, the binder is used in an amount of 1 to 5 wt % based on a total weight of the binding mixture.

4. The method for manufacturing coffee activated carbon according to claim 1, wherein the impregnating agent includes at least one selected from the group consisting of piperazine, arginine, alanine, glutamine, glycine, threonine, and histidine.

5. The method for manufacturing coffee activated carbon according to claim 1, wherein in the post-treatment process, the coffee activated carbon is immersed in an impregnating agent composition in which the impregnating agent is included in an amount of 2 to 10 wt % based on a total weight of the impregnating agent composition.

6. The method for manufacturing coffee activated carbon according to claim 1, wherein the pretreatment process comprises:
performing, by the sieve, a first sieving process of sieving the coffee waste and recovering the coffee powder particles from the coffee waste;
performing a binding process of manufacturing the coffee grains by molding the binding mixture including the recovered coffee powder particles and the binder; and
performing, by the oven device, a first drying process of drying the coffee grains to remove moisture.

7. The method for manufacturing coffee activated carbon according to claim 6, wherein in the first sieving process, the coffee waste is sieved with the sieve which has a sieve opening of 1900 μm to 4040 μm, and
wherein the coffee grains manufactured in the binding process have an average particle diameter D₅₀ of 3000 μm.

8. The method for manufacturing coffee activated carbon according to claim 6, wherein in the binding process, the binding mixture includes 95 to 99 wt % of the coffee powder particles, 1 to 5 wt % of the binder, and remaining water based on a total weight of the binding mixture.

9. The method for manufacturing coffee activated carbon according to claim 1, wherein the main treatment process comprises:
performing a carbonization process of carbonizing the coffee grains; and
performing an activation process of activating the carbonized coffee grains and manufacturing the coffee activated carbon.

10. The method for manufacturing coffee activated carbon according to claim 9, wherein in the carbonization process, the coffee grains are added into the thermal decomposition furnace and carbonized at a temperature of 300° C. to 750° C.

11. The method for manufacturing coffee activated carbon according to claim 10, wherein an inert gas is added into the thermal decomposition furnace to carbonize the coffee grains, and the inert gas is at least one selected from the group consisting of nitrogen (N₂), carbon dioxide (CO₂), and argon (Ar).

12. The method for manufacturing coffee activated carbon according to claim 9, wherein in the activation process, the carbonized coffee grains and active gas are added into the thermal decomposition furnace, and the carbonized coffee grains are activated at a temperature of 900° C. to 1,100° C. to manufacture the coffee activated carbon.

13. The method for manufacturing coffee activated carbon according to claim 12, wherein the active gas is at least one selected from the group consisting of steam (H₂O), carbon dioxide (CO₂), potassium hydroxide (KOH), sodium hydroxide (NaOH), potassium carbonate (K₂CO₃), zinc chloride (ZnCl₂), and phosphoric acid (H₃PO₄).

14. The method for manufacturing coffee activated carbon according to claim 9, wherein the main treatment process further comprises:
a stabilization process of fixing and stabilizing the coffee activated carbon at room temperature after the performing an activation process.

15. The method for manufacturing coffee activated carbon according to claim 1, wherein the post-treatment process further comprises:
performing a second sieving process of sieving the coffee activated carbon and selecting coffee activated carbon having an average particle diameter D₅₀ of 320 μm;
performing a second drying process of drying the selected coffee activated carbon to remove moisture; and
performing an impregnation process of impregnating the impregnating agent to the dried coffee activated carbon.

16. The method for manufacturing coffee activated carbon according to claim 15, wherein in the second drying process, the coffee activated carbon is sieved with a second sieve which has a sieve opening of 185 μm to 864 μm.

17. The method for manufacturing coffee activated carbon according to claim 15, wherein in the second sieving process, the coffee activated carbon includes 5 wt % or less of moisture based on a total weight of the coffee activated carbon by removing the moisture.

18. Coffee activated carbon manufactured according to the method for manufacturing coffee activated carbon according to claim 1, in which an impregnating agent including an amine group is impregnated.

19. Coffee activated carbon according to claim 18, wherein the coffee activated carbon has a BET specific surface area of 1000 m²/g or more and an average particle diameter D₅₀ of 320 μm.

20. A combi filter for a vehicle air conditioning system, including the coffee activated carbon of claim 18.
